(19) United States
(12) Patent Application Publication
(10) Pub. No.: US 2011/0295659 A1
(43) Pub. Date: Dec. 1, 2011

(54) SYSTEM OF DELIVERING ADVERTISEMENTS VIA WIRELESS NETWORK

(76) Inventor: MARCUS KRIETER, Newport Beach, CA (US)

(21) Appl. No.: 12/787,370

(22) Filed: May 25, 2010

(51) Int. Cl. G06Q 30/00; G08B 5/00; G06F 15/16

(52) U.S. Cl. 705/14.4; 340/815.4; 709/203

(57) ABSTRACT

A system for delivering advertisements is provided. The system comprises a server, an active device, and an inactive device. The server is configured to store an advertising message. The active device is coupled to the server and configured to receive the advertising message. The active device receives the advertising message from the server upon occurrence of an event. The inactive device is coupled to the server. The inactive device is substantially similar to the active device.

### FIELD OF INVENTION

The invention relates to advertising material, and more particularly, to a system for delivering advertisements and promotional alerts.

### BACKGROUND

Advertising is a form of communication intended to influence and attract consumers to purchase products or services. Advertisers constantly seek ways to capture consumer attention by creating advertisements for new and established products and services. As such, advertisers devise different types of innovative and thought-provoking advertising concepts for promoting their products in order to win market share over the competition.

Various conventional media used by advertisers for advertising includes printed media such as magazines, newspapers, wall paintings, billboards, street furniture components, shopping carts, and other such media. Currently, the more popular forms of media used for commercial advertisement include electronic media such as radio, television, cinema, mobile advertisements, web advertisements, audio and video streaming, and the like. However, the above mentioned conventional forms of advertising may not be very effective since the consumer tends to pay attention to the advertised product or service only while they are viewing the advertisement. Thereafter, the advertised product or service is typically soon forgotten by the consumer shortly after viewing the advertisement.

Accordingly, an effective marketing campaign may require the consumer to be constantly aware of a product or service being advertised, thereby imprinting the said product or service into the customer's mind. Further, the mode of advertising must be cost effective for facilitating extensive marketing of products and services.

In light of the foregoing limitations, there is a need for providing advertising solutions that may encourage consumers to constantly pay attention to the advertised product or service, thereby facilitating constant promotion of the advertised product or service. Moreover, there is a need for providing cost-effective advertising solutions.

### BRIEF SUMMARY OF THE INVENTION

An object of the present invention is to provide advertising solutions that encourages consumers to constantly pay attention to an advertised product or service, thereby facilitating effective promotion of the advertised product or service.

Another object of the present invention is to provide cost effective solutions for advertisement and promotions, such as for brand advertisements, sweepstakes, and the like.

To achieve the objects of the present invention, a system for delivering advertisements is provided. The system comprises a server, an active device, and an inactive device. The server is configured to store an advertising message. The active device is coupled to the server and configured to receive the advertising message. The active device receives the advertising message from the server upon occurrence of an event. The inactive device is coupled to the server. The inactive device is substantially similar to the active device.

### BRIEF DESCRIPTION OF THE DRAWINGS

The preferred embodiments of the invention will hereinafter be described in conjunction with the figures provided herein to further illustrate various non-limiting embodiments of the invention, wherein like designations denote like elements, and in which:

FIG. 1 illustrates an exemplary environment including a system for delivering advertisements, in accordance with an embodiment of the present invention.

FIG. 2 illustrates a perspective view of a portable device for receiving advertisements, in accordance with an embodiment of the present invention.

### DETAILED DESCRIPTION OF THE EMBODIMENTS

In the following detailed description of the embodiments of the invention, numerous specific details are set forth in order to provide a thorough understanding of the embodiments of the invention. However, it will be obvious to one skilled in the art that the embodiments of the invention may be practiced without these specific details. In other instances well known methods, procedures, components, and circuits have not been described in detail so as not to unnecessarily obscure aspects of the embodiments of the invention.

Furthermore, it will be clear that the invention is not limited to these embodiments only. Numerous modifications, changes, variations, substitutions and equivalents will be apparent to those skilled in the art without departing from the spirit and scope of the invention.

The embodiments of the invention include a system for delivering advertisements, and a portable device for receiving advertisements. Particularly, the invention discloses a system comprising a server, an active device, and an inactive device. The server is configured to store an advertising message. The active device is coupled to the server and configured to receive the advertising message. The active device receives the advertising message from the server upon occurrence of an event. The inactive device is coupled to the server. The inactive device is substantially similar to the active device.

As disclosed herein, the term ‘advertising message’ may refer to the information regarding products, goods, services, contest, lotteries, sweepstakes, promotional events, and the like. Specifically, the information may also refer to alerts, such as the announcement of a winner, the announcement of a winning number or code, a participating partner brand, offers and promotions recommended during an event, and the like.

The consumer having the active device may receive advertisement messages on the active device thereof via the wireless network. Such advertisement messages may be provided to the consumers' active device for a limited period of time (hereinafter referred to as ‘promotional period’). Accordingly, during the promotional period, the consumer may keep the active device in immediate vicinity for being alerted about the advertisement message.

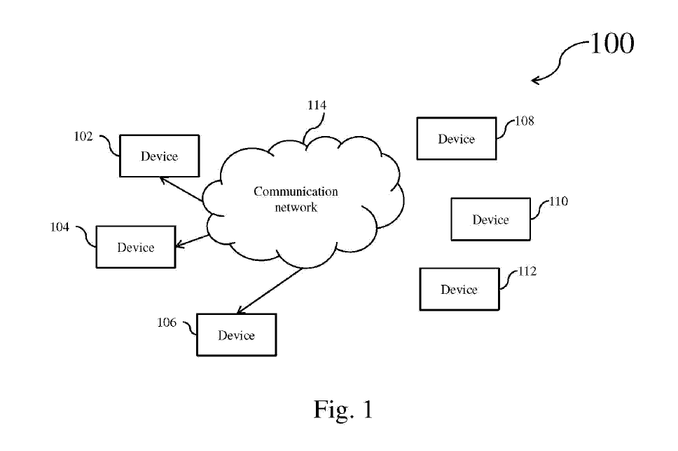

Referring to FIG. 1, FIG. 1 illustrates an exemplary environment 1000 including a system 100 for delivering advertisements, in accordance with an embodiment of the present invention. The system 100 includes an active device 102, an inactive device 104, and a server 106. As illustrated in FIG. 1, the environment 1000 includes the system 100, and a wireless network 110.

The active device 102 and the inactive device 104 are coupled to the server via the wireless network 110. In an embodiment, the wireless network 110 is selected from a group consisting of a cellular network, a Wireless Local Area Network (WLAN), a Radio Frequency Identification (RFID) network, a Bluetooth network, and a Zigbee network. In an embodiment, the wireless network 110 is any network enabling the transmission of signals associated with advertisement messages to the active device 102.

The server 106 is configured to store advertising messages. It will be evident to those skilled in the art that the server 106 may be a typical server servicing Internet traffic and may include requisite repository for storing advertising messages.

The active device 102, coupled to the server 106, is configured to receive an advertising message from the server 106 via the wireless network 110. The active device 102 is configured to receive the advertising message from the server 106 upon occurrence of an event. In an embodiment, the event is selected from a group consisting of a sweepstakes announcement, a lottery announcement, an event announcement, a store opening announcement, and a promotional announcement.

In an embodiment, the active device 102 may be configured to include a memory for storing the advertisement message for later retrieval. In an embodiment, the active device 102 may be configured with a Random Access Memory (RAM), Read Only Memory (ROM), a flash memory and the like, for storing the advertisement message for later retrieval.

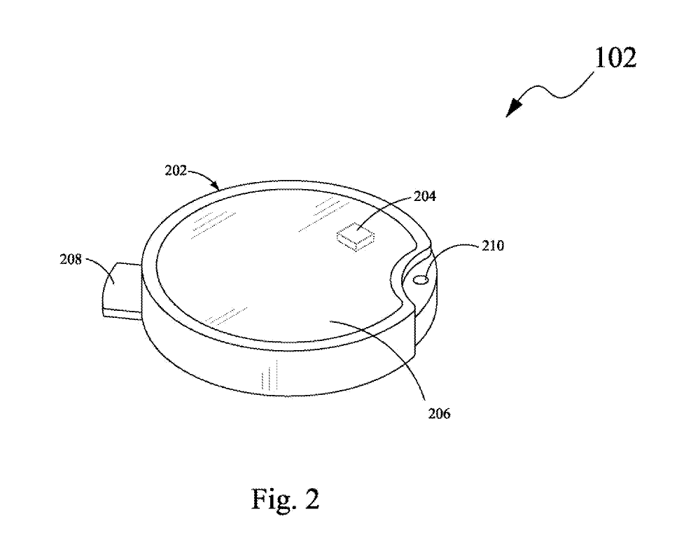

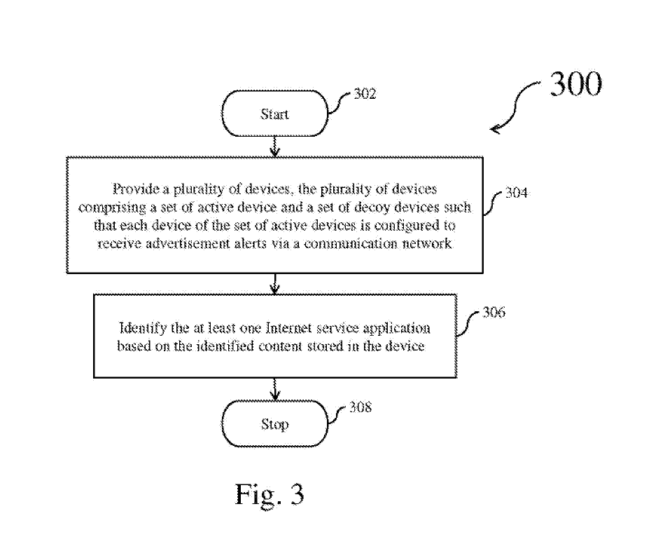

The inactive device 104, coupled to the server 106, is substantially similar to the active device 102. It will be evident to a person skilled in the art that the inactive device 104 though coupled to the server 106 may not be able to receive the advertisement message on account of an inactive status. In an embodiment, the inactive device 104 is transformed into an active device, such as an active device 102, upon activation of the inactive device 104. The transformation of the inactive device 104 into the active device is explained in detail in conjunction with FIG. 2.

Though FIG. 1 is depicted to include an active device 102 and an inactive device 104, it will be obvious to a person skilled in the art that the system 100 includes a plurality of active devices, such as the active device 102, and a plurality of inactive devices, such as the inactive device 104.

Promoters of goods and services may provide active devices, such as active devices 102, and inactive devices, such as inactive device 102, to potential consumers during promotional events or at vendor locations or at popular outlets. The inactive devices may need to be transformed into active devices for receiving advertisement messages. The active devices may receive advertisement messages from a server, such as the server 106, storing advertisement messages. In addition to the active devices and the inactive devices, promoters of goods and services may also provide decoy or dummy devices to potential consumers. The decoy and dummy devices may be unable to receive advertisement messages, and, as such may only serve to increase excitement about the actual active devices or increase excitement about the goods and the services being promoted. It will be understood that the shape, size and weight of the decoy devices are substantially or exactly similar to the active devices. To avail promotional offers and advertisement alerts, the consumer may need to keep the active devices in vicinity, and, as such the active devices need to be configured to be portable. A portable active device is explained in conjunction with FIG. 2.

Referring to FIG. 2, FIG. 2 illustrates a perspective view of a portable active device 102 (hereinafter referred to as device 102) for receiving advertisements, in accordance with an embodiment of the present invention. It should be understood that the present invention will be described with reference to the device 102, however the teaching of the invention are similarly applicable to all other active devices also without departing from the novelty and scope of the invention.

The device 102 is capable of receiving advertisement from a server, such as a server 106 of FIG. 1, via the wireless network, such as wireless network 110. The device 102 includes a housing 202, a radio receiver 204 placed within the housing 202, an alerting means 206 placed adjacent to the housing 202, and an activation member 208 communicatively coupled to the radio receiver 204. The device 102 further comprises an external attachment member 210 placed on the housing 202.

The radio receiver 204 may be integrated in the housing 202 of the device 102 and configured to receive signals associated with the advertisement messages. As explained in conjunction with FIG. 1, the device 102 may be configured to receive the advertising message from a remote server, such as the server 106, upon occurrence of an event, such as a sweepstakes announcement, a lottery announcement, an event announcement, a store opening announcement, and a promotional announcement. On occurrence of the event, the radio receiver 204 receives the advertising message from a remote server and communicates the advertisement message to the alerting means 206. The alerting means 206 is configured to generate output indicative of the advertisement message in response to the received signals.

The remote server can include storage means, such as a database or repository, to store advertisements, routing information, demographics, and other related information. In an embodiment, the remote server can be part of a satellite based network, or a cellular network that interfaces with a GPS network.

In another embodiment, the remote server can be configured to allow two-way, or bi-directional communications, between the device and the advertising network. This allows a user to use the device to transmit information such as survey or poll answers, sweepstakes enrollment, and other personal preference or selection information, to the advertising network.

In FIG. 2, the alerting means 206 is depicted to be a display screen configured to display advertising data, such as the advertising message, received by the radio receiver 204 from the remote server. The display screen is configured to display indicia (not shown) thereon having information associated with an advertisement. The indicia may be imprinted or engraved on the display screen. The information may include promotional materials such as slogans, logos and the like. For example, said device 102 may be utilized by a beverage company for promotion of its brands, and accordingly, the beverage company may distribute devices, such as device 102 having information regarding the beverage brand and the company name, slogan, or trademark printed thereon. Optionally, the information may also include contact details and a website address of the beverage company. Moreover, the information may also include a unique identifier such as a serial number for identifying a consumer possessing the device 102. In an embodiment of the present invention, the display screen is a Liquid Crystal Display (LCD) screen. In another embodiment of the present invention, the display screen is a Light Emitting Diode (LED) screen. Alternatively, the display screen may include a silver screen on each face of the display screen that may be illuminated by a LED configured under each silver screen. Accordingly, the silver screen may be illuminated when an advertisement message is received by the radio receiver 204.

In an embodiment, the alerting means 206 is a vibrating member configured to vibrate upon receiving a signal from the radio receiver 204. In another embodiment, the alerting means 206 is a speaker configured to emit an audible tone upon receiving a signal from the radio receiver 204. An example of an audible tone could be a jingle of a company. It will be understood to a person skilled in the art that the advertisement messages could be provided to the consumer by any of the above mentioned forms of indications or a combination thereof or any other known form of indication without departing from the scope of the present invention.

The activation member 208 is configured to activate the radio receiver 204. In FIG. 2, the activation member 208 is depicted to be a pullable-strip. The pullable-strip is removably attached to the housing 202 such that the removal of the pullable-strip 208 facilitates activation of the device 102 for receiving the advertisement messages. The pullable-strip may be pulled away from the housing 202 for activating the device 102. In an embodiment, the activation member 208 is one of a trigger and a push-button, such that operating the trigger or the push button activates the device 102 for receiving advertisement messages and alerts. The activation of a device transforms an inactive device, such as device 104 in FIG. 1 into an active device, such as device 102, that is, enables the inactive device to receive the advertisement messages.

The activation of the device 102 may include activation of the radio receiver 204. In an embodiment, the radio receiver 204 is configured to transmit an activation signal to the remote server upon activation of the radio receiver 204 by the activation member 208.

In FIG. 2, the housing 202 of the device 102 is shaped so as to include the external attachment member 210 in form of a key ring attachment configured to attach to a keychain ring or keyfob ring. The key ring attachment may enable a consumer or a user to conveniently carry the device 102 during the promotional period of the advertisement. It will be understood that the present invention is illustrated and explained assuming the shape of housing 202 the device 102 to include a key ring attachment. However, it should be understood that the shape of the housing 202 may vary depending on alternative attaching means configured on the device 102. For example, the device 102 may optionally or additionally include at least one pin (not shown) for attaching the device 102 to an article of clothing, such as an accessory or an apparel of the consumer, thereby enabling the consumer to conveniently wear the device.

In FIG. 2, the housing 202 is depicted to be in the form of a substantially circular shaped medallion. However, it will be understood to a person skilled in the art that the housing 202 may assume any other shape known in the art such as oval shape, square shape, triangle shape, rectangular shape, star shape, moon shape, shape of an animal, bird, and the like.

As explained in conjunction with FIG. 1, the device 102 may include a memory (not shown in FIG. 2) for storing the advertisement messages for later retrieval. In an embodiment, the device 102 may be configured with a Random Access Memory (RAM), Read Only Memory (ROM), a flash memory and the like, within the housing for storing the advertisement messages for later retrieval.

In an embodiment, an advertiser may organize a promotional activity or event. The promotional event may be organized for a short period of time, for example, for a number of weeks or months. As part of the event, the advertiser may distribute a plurality of devices to consumers. The plurality of devices may include active devices such as the device 102, inactive devices such as inactive device 104, and a set of dummy or decoy devices as explained in conjunction with FIG. 1. Each of the active devices is capable of receiving advertisement alerts from a remote server, such as server 106 of FIG. 1, via the wireless network 114. The active devices may be similar to device 102 of FIG. 2.

The inactive devices may be activated by activation member, such as the activation member 208. In another embodiment, after receiving the active device, the consumer may call an activation phone number, such as a toll-free number, or visit a website and enter the serial number of the device, to activate the device. In yet another embodiment, the consumer may take the device to a vendor or advertiser's store to have the device activated.

The active devices may be kept in the immediate vicinity of the consumers for enabling the consumers to be informed about the advertisement alert on the device. During the promotional period, advertisement alerts may be provided to the active devices. For example, during an advertising event, the advertiser may declare three consumers as winners, and accordingly may provide advertisement alerts on the three devices via the wireless network.

In an embodiment, the winner consumers may contact the advertiser utilizing the indicia printed on the housing of the device. The printed indicia may include the contact information, website address, toll free number and the like of the advertiser. In another exemplary embodiment, the consumer may need to participate in any other media event and may need to provide information regarding the event within a specified period of time upon receiving the advertisement alert in order to be able to win during the promotional event. Accordingly, the advertiser may form tie-ins with television and other media programs and events.

Various embodiments of the present invention provide a system for delivering advertisements and a portable device for receiving advertisements. The system necessitates the consumer to keep the device in close vicinity of the advertiser or event during the promotional period and so that the consumer pays attention to the same. Accordingly, the invention facilitates in effective promotion of the advertised products and services among consumers. Additionally, the present invention provide a cost-effective solution for advertising by providing a set of decoy devices that may look exactly similar to the active devices, thereby allowing overall reduction in the cost of advertising.

The invention has been described using example of a substantially circular shaped medallion used in advertising via a wireless network. However, a person skilled in the art can easily understand that the described advertising system and device can be used for various purposes such as, lotteries, sweepstakes, and gaming events that require distribution of such devices for promotional or other such purposes. Therefore, objects and embodiments of the invention should be construed according to the claims that follow below.

While the principles of the disclosure have been illustrated in relation to the exemplary embodiments shown herein, the principles of the disclosure are not limited thereto and include any modification, variation or permutation thereof.

What is claimed is:

1. A system of delivering advertisements, comprising:
a server configured to store an advertising message;
an active device coupled to the server and configured to receive the advertising message;
an inactive device coupled to the server, the inactive device substantially similar to the active device; and
a decoy device substantially similar in appearance to the active device, the decoy device not coupled to the server and the decoy device unable to receive the advertising message,
wherein the active device receives the advertising message from the server upon occurrence of an event.

2. The system of claim 1, wherein the event is selected from a group consisting of a sweepstakes announcement, a lottery announcement, an event announcement, a store opening announcement, and a promotional announcement.

3. The system of claim 1, wherein the active device and the inactive device are coupled to the server via a wireless network.

4. The system of claim 3, wherein the wireless network is selected from a group consisting of a cellular network, a Wireless Local Area Network (WLAN), a Radio Frequency Identification (RFID) network, a Bluetooth network, and a Zigbee network.

5. The system of claim 3, wherein the inactive device is transformed into an active device upon activation of the inactive device.

6. The system of claim 1, wherein the active device includes a memory for storing the advertising message for later retrieval.

7. A portable device for receiving advertisements, the portable device comprising:
a housing;
a radio receiver placed within the housing;
an alerting means placed adjacent to the housing; and
an activation member placed adjacent to the housing, the activation member communicatively coupled to the radio receiver.

8. The portable device of claim 7, further comprising an external attachment member placed on the housing.

9. The portable device of claim 7, wherein the alerting means is a display screen configured to display advertising data received by the radio receiver from a remote server.

10. The portable device of claim 7, wherein the alerting means is a vibrating member configured to vibrate upon receiving a signal from the radio receiver.

11. The portable device of claim 7, wherein the alerting means is a speaker configured to emit an audible tone upon receiving a signal from the radio receiver.

12. The portable device of claim 7, wherein the activation member is configured to activate the radio receiver.

13. The portable device of claim 7, wherein the activation member is a pullable-strip.

14. The portable device of claim 7, wherein the activation member is one of a trigger and a push-button.

15. The portable device of claim 7, wherein the radio receiver is configured to transmit an activation signal to a remote server upon activation of the radio receiver by the activation member.

16. A portable device for receiving advertisements, the portable device comprising:
a housing;
a radio receiver placed within the housing;
a display screen placed adjacent to the housing;
a pullable-strip member placed adjacent to the housing, the pullable strip member communicatively coupled to the radio receiver; and
an external attachment member placed on the housing.

17. The portable device of claim 16, wherein the display screen is a Light Emitting Diode (LED) screen.

18. The portable device of claim 16, wherein the display screen is a Liquid Crystal Display (LCD) screen.

19. The portable device of claim 16, wherein the external attachment member is a pin configured to attach to an article of clothing.

20. The portable device of claim 16, wherein the external attachment member is a key ring attachment configured to attach to a keychain ring or keyfob ring.
